(19) United States
(12) Patent Application Publication
(10) Pub. No.: US 2026/0050796 A1
(43) Pub. Date: Feb. 19, 2026

(54) FEDERATED LEARNING WITH INCREASED RESOURCE UTILIZATION

(71) Applicant: Rakuten Mobile, Inc., Tokyo (JP)

(72) Inventors: Zihan ZHANG, St Andrews (GB); Jee Chang, Leon WONG, Tokyo (JP); Blesson VARGHESE, St Andrews (GB)

(21) Appl. No.: 18/803,957

(22) Filed: Aug. 14, 2024

(51) Int. Cl. G06N 3/098

(52) U.S. Cl. CPC G06N 3/098

(57) ABSTRACT

Federated learning with increased resource utilization is performed by performing computation iterations while maintaining an activation queue and a model queue. Each computation iteration includes: determining whether to perform aggregation, and then either adjusting, in response to determining to perform aggregation, parameters of the aggregated device model and the aggregated auxiliary model based on a first updated device model and corresponding first updated auxiliary model among the plurality of updated models in the model queue, or training, in response to not determining to perform aggregation, the server model based on a first activation set among the plurality of activation sets in the activation queue.

### BACKGROUND

### Technical Field

The present disclosure relates to federated learning with increased resource utilization.

### Background Art

In classic Federated Learning (FL), a central server and multiple devices collaborate in iterative training via two stages: training and aggregation. During the training stage, each participating device independently trains a local model on its data and subsequently uploads the model to the central server. After receiving all local models, in the aggregation stage, the server combines the local models into a global model that is then distributed back to the devices. Subsequently, the next iteration commences. Therefore, FL utilizes the insights from user data via local models to train a global model without sharing the original data used to create the local models.

### SUMMARY

Federated learning with increased resource utilization is performed by maintaining an activation queue by adding, upon reception from a corresponding device among a plurality of devices, each activation set among a plurality of activation sets in the activation queue, each activation set having been output from a device model of a neural network model, the neural network model including a plurality of layers partitioned into the device model and a server model, maintaining a model queue by adding, upon reception from a corresponding device among the plurality of devices, each updated device model and corresponding updated auxiliary model among a plurality of updated models in the model queue, transmitting an aggregated device model and an aggregated auxiliary model to the corresponding device in response to reception of each updated device model and corresponding updated auxiliary model, performing computation iterations while maintaining the activation queue and the model queue, each computation iteration including: determining whether to perform aggregation, adjusting, in response to determining to perform aggregation, parameters of the aggregated device model and the aggregated auxiliary model based on a first updated device model and corresponding first updated auxiliary model among the plurality of updated models in the model queue, and training, in response to not determining to perform aggregation, the server model based on a first activation set among the plurality of activation sets in the activation queue.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic diagram of a system for federated learning with increased resource utilization, according to at least some embodiments of the subject disclosure.

FIG. 2 is a schematic diagram of a model for federated learning with increased resource utilization, according to at least some embodiments of the subject disclosure.

FIG. 3 is an operational flow for federated learning with increased resource utilization on a server, according to at least some embodiments of the subject disclosure.

FIG. 4 is an operational flow for maintaining queues, according to at least some embodiments of the subject disclosure.

FIG. 5 is an operational flow for performing computations, according to at least some embodiments of the subject disclosure.

FIG. 6 is an operational flow for aggregating device model, according to at least some embodiments of the subject disclosure.

FIG. 7 is an operational flow for training a server model, according to at least some embodiments of the subject disclosure.

FIG. 8 is an operational flow for federated learning with increased resource utilization on a device, according to at least some embodiments of the subject disclosure.

FIG. 9 illustrates an embodiment of a device for federated learning with increased resource utilization, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

In classic FL, a bottleneck is sub-optimal resource utilization that creates idle time on the server and devices. Servers typically have more computational resources than devices and run aggregation tasks after the local model training is completed on the devices. Since local training can be time-consuming, the server remains idle for considerable periods waiting for the local models. Idle time on devices arises from hardware heterogeneity as there will be stragglers (slower devices) during training. At the end of an iteration, each device needs to obtain the aggregated model from the server for training in the next iteration. However, the aggregation task requires local models from all devices. The straggler dictates the aggregation, thereby causing faster devices to remain idle while waiting for the stragglers to complete training. This makes FL impractical.

In Offloading-based FL (OFL) methods known to the inventors, a model is partitioned across both the server and the devices to leverage computational resources on the server and alleviate the computational burden on the devices. Asynchronous FL (AFL) methods known to the inventors allow local models to be aggregated into the global model whenever the server receives them, thereby enabling devices to work independently of each other to minimize the impact of stragglers. However, these methods do not reduce the idle time on both the server and devices simultaneously. Simply combining OFL and AFL methods is not effective because the limitations of both OFL and AFL will be inherited by the combined method.

At least some embodiments described herein increase resource utilization during federated learning by splitting a neural network model into a server model and a device model, such that each device trains a corresponding device model with an auxiliary model, and the server aggregates parameters of the trained device models and auxiliary models of all devices asynchronously, whereas the server only trains one server model in a centralized way on the intermediate results (activations) received from all devices.

In at least some embodiments, the server decreases idle time by aggregating trained device models whenever possible, and training the server model when not. In at least some embodiments, the server decreases device idle time by enabling each device to operate independently without waiting for the server or any other devices. In at least some embodiments, the server includes a task scheduler to balance the number of used activations among the devices. In addition, the server memory is efficiently managed by controlling the flow of incoming activations in at least some embodiments, which improves server resource utilization and device scalability.

Auxiliary networks are known to the inventors for use in local learning. In at least some embodiments, the server generates and aggregates an auxiliary network along with the global network and server-side and device-side networks. In at least some embodiments, auxiliary networks are trained and aggregated in the same way as device-side networks. In at least some embodiments, the auxiliary network is a compressed version (e.g. −1 or 2 layers) of the server-side network. In at least some embodiments, the loss function for training the device-side and auxiliary network is the same as what the server uses for training the server-side model.

In at least some embodiments, each of the devices and the server have a separate transmitter and receiver to operate in parallel. In at least some embodiments, the server includes a task scheduler configured to decide whether to train or aggregate, and which activations to prioritize for balanced training. In at least some embodiments, each device transmits activations in sets of a mini-batch. In other embodiments, activation sets are different sizes and proportions to batches.

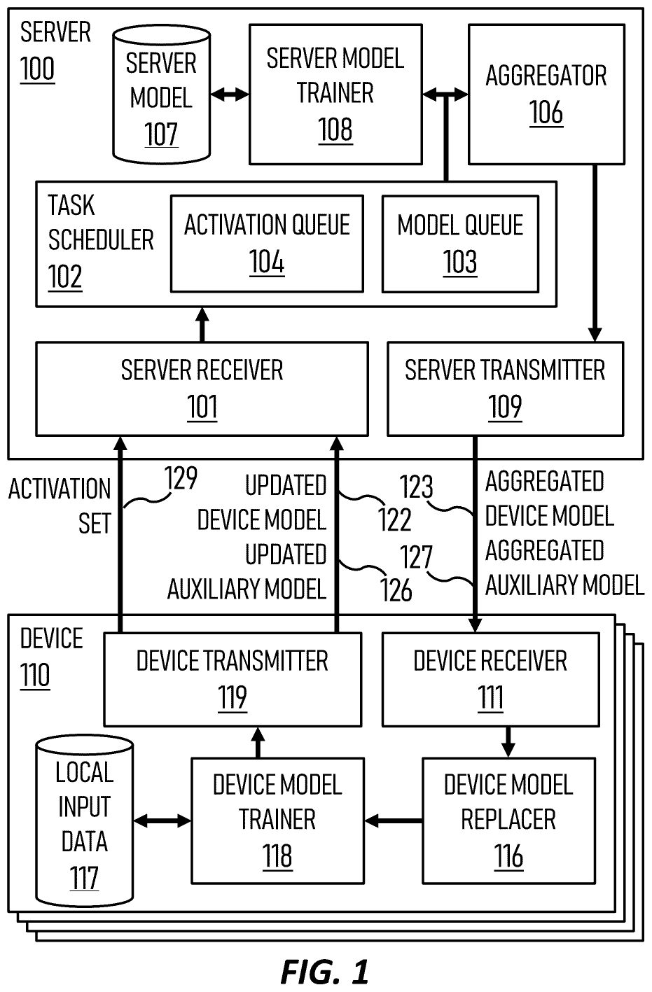

FIG. 1 is a schematic diagram of a system for federated learning with increased resource utilization, according to at least some embodiments of the subject disclosure. The system includes server 100, and a plurality of devices, such as device 110, updated device model 122, updated auxiliary model 126, aggregated device model 123, aggregated auxiliary model 127, and activation set 129.

Server includes server receiver 101, task scheduler 102, model queue 103, activation queue 104, aggregator 106, server model 107, server model trainer 108, server transmitter 109, and interacts with devices, such as device 110, to receive activation sets, such as activation set 129, and updated models, such as updated device model 122 and updated auxiliary model 126, and to transmit aggregated models, such as aggregated device model 123 and aggregated auxiliary model 127. In at least some embodiments, server 100 is configured to coordinate the federated learning process. In at least some embodiments, the configuration of server 100 is not limited to federated learning, and is further configured for hosting websites, databases, and other services. In at least some embodiments, server 100 is a computer or cloud server, such as a server in a data center. In at least some embodiments, server 100 is configured to handle multiple connections and computations.

Server receiver 101 is configured to receive data. In at least some embodiments, server receiver 101 is configured to receive updated models, such as updated device model 122 and updated auxiliary model 126, and activation sets from the devices, such as activation set 129. In at least some embodiments, server receiver 101 is a network interface card (NIC) in a server. In at least some embodiments, server receiver 101 is configured to receive other data from the devices or other sources.

Task scheduler 102 includes model queue 103 and activation queue 104, and is in communication with server receiver 101, server model trainer 108, and aggregator 106. In at least some embodiments, task scheduler 102 is configured to determine whether to perform aggregation or train the server model. In at least some embodiments, task scheduler 102 is a software module running on server 100. In at least some embodiments, task scheduler is configured to determine a schedule for training by ordering activation sets in activation queue 104.

Model queue 103 is a data structure. In at least some embodiments, model queue 103 represents an order of the updated models received from devices, such as device 110. In at least some embodiments, model queue 103 is a portion of memory of server 100. In at least some embodiments, data of model queue 103 is stored independently of data of the updated models received from devices. In at least some embodiments, model queue 103 is a First-In-First-Out (FIFO) memory storing each updated device model and corresponding updated auxiliary model in the order received.

Activation queue 104 is a data structure. In at least some embodiments, activation queue 104 is similar to model queue 103. In at least some embodiments, activation queue 104 represents an order of the activation sets received from devices, such as device 110. In at least some embodiments, activation queue 104 comprises an independent queue for each device. In at least some embodiments, activation queue 104 is a portion of memory of server 100.

Aggregator 106 is in communication with task scheduler 102 and server transmitter 109. In at least some embodiments, aggregator 106 is configured to adjust the parameters of the aggregated device model and the aggregated auxiliary model. In at least some embodiments, aggregator 106 is configured to adjust based on the updated models in model queue 103. In at least some embodiments, aggregator 106 is a software module running on server 100.

Server model 107 is a part of the neural network model. In at least some embodiments, server model 107 resides on server 100. In at least some embodiments, server model 107 is trained based on the activations in activation queue 104. In at least some embodiments, server model 107 is a matrix of weights. In at least some embodiments, server model 107 is a computation sequence. In at least some embodiments, server model 107 includes the output layer of the neural network model.

Server model trainer 108 trains server model 107. In at least some embodiments, server model trainer 108 trains server model 107 based on the activations in activation queue 104. In at least some embodiments, server model trainer 108 interacts with server model 107 and activation queue 104. In at least some embodiments, server model trainer 108 is a software module running on server 100.

Server transmitter 109 is configured to transmit data. In at least some embodiments, server transmitter 109 transmits aggregated device models, such as aggregated device model 123, and aggregated auxiliary models, such as aggregated auxiliary model 127, to the devices, such as device 110. In at least some embodiments, server transmitter 109 is a network interface card (NIC). In at least some embodiments, server transmitter 109 and server receiver 101 are parts of a network interface card (NIC).

Device 110 includes device receiver 111, device model replacer 116, local input data 117, device model trainer 118, and device transmitter 119, and interacts with server 110 to transmit activation sets, such as activation set 129, and updated models, such as updated device model 122 and updated auxiliary model 126, and to receive aggregated models, such as aggregated device model 123 and aggregated auxiliary model 127. In at least some embodiments, device 110 is any computing device capable of processing data and running machine learning models. In at least some embodiments, device 110 is a smartphone, a laptop, or an IoT device.

Device receiver 111 is configured to receive data. In at least some embodiments, device receiver 111 is configured to receive aggregated device models and aggregated auxiliary models from server 100. In at least some embodiments, device receiver 111 is configured to interact with device model replacer 116 to replace the existing model with the received model. In at least some embodiments, device receiver 111 is a communication module that receives data. In at least some embodiments, device receiver 111 is a part of a network interface of device 110.

Device model replacer 116 is in communication with device receiver 111 and device model trainer 118. In at least some embodiments, device model replacer 116 is configured to replace the existing device model and auxiliary model with the received models. In at least some embodiments, device model replacer 116 is configured to interact with device receiver 111 to get the new models and with device model trainer 118 to provide the new models for training. In at least some embodiments, device model replacer 116 is configured to replace the received models in a memory of device 110 allocated for models. In at least some embodiments, device model replacer 116 is a function or method in a machine learning library. In at least some embodiments, device model replacer 116 is a software module running on device 110.

Local input data 117 is the data used by device model trainer 118. In at least some embodiments, local input data 117 is the data used for training device models and auxiliary models. In at least some embodiments, local input data 117 includes data used for machine learning tasks, such as images, text, audio recordings, etc.

Device model trainer 118 is in communication with device model replacer 116 and device transmitter 119. In at least some embodiments, device model trainer 118 is configured to train the device model and auxiliary model using local input data 117. In at least some embodiments, device model trainer 118 is a training module in a machine learning system. In at least some embodiments, device model trainer 118 communicates with device transmitter 119 to indicate when the trained models are ready for transmission to the server. In at least some embodiments, device model trainer 118 is a function or method in a machine learning library. In at least some embodiments, device model trainer 118 is a software module running on device 110.

Device transmitter 119 is configured to transmit data. In at least some embodiments, device transmitter 119 is a component in device 110 that transmits updated device models and auxiliary models, which were trained by device model trainer 118, to server 100. In at least some embodiments, device transmitter 119 is configured to transmit updated device models and updated auxiliary models, such as updated device model 122 and updated auxiliary model 126, and activation sets from the devices, such as activation set 129. In at least some embodiments, device transmitter 119 is a communication module that transmits data. In at least some embodiments, device transmitter 119 is a part of a network interface of device 110. In at least some embodiments, device transmitter 119 is a part of the same network interface as of device receiver 111.

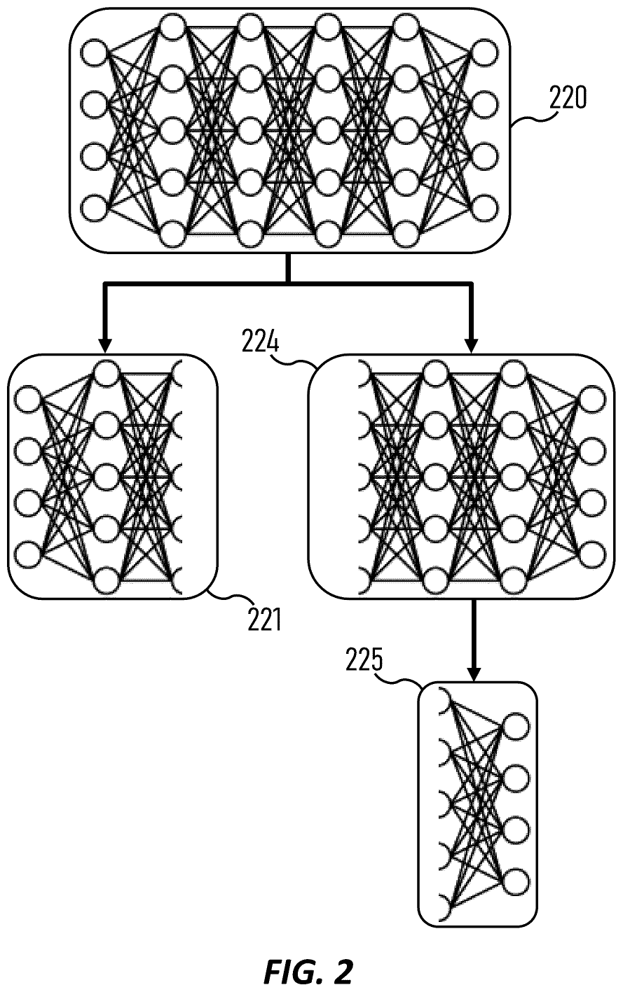

FIG. 2 is a schematic diagram of a model set for federated learning with increased resource utilization, according to at least some embodiments of the subject disclosure. The model set includes full model 220, device model 221, server model 224, and auxiliary model 225.

Full model 220 is a complete neural network model. In at least some embodiments, full model 220 is partitioned into device model 221 and server model 224 for the purpose of federated learning with increased resource utilization. In at least some embodiments, full model 220 is a machine learning model. In at least some embodiments, full model 220 is represented as a data structure in a machine learning library. In at least some embodiments, full model 220 is suitable for various formats and products. In at least some embodiments, full model 220 is a Deep Neural Network (DNN), a Large Language Model (LLM), or any other neural network model.

Device model 221 is a partition of full model 220 that includes the input layer. In at least some embodiments, device model 221 is trained on the device through local learning with auxiliary model 225. In at least some embodiments, device model 221 is a machine learning model trained on a device rather than on a server. In at least some embodiments, device model 221 is represented as a data structure. In at least some embodiments, layers that are included in device model 221 are identical in dimensionality, type, and order to full model 220. In at least some embodiments, any layers of full model 220 that are not included in device model 221 are included in server model 224.

Server model 224 is a partition of full model 220 that includes the output layer. In at least some embodiments, server model 224 is trained on the server rather than on a device. In at least some embodiments, training server model 224 is trained using activation sets output from device models, such as device model 221. In at least some embodiments, server model 224 is a machine learning model trained on a server. In at least some embodiments, server model 224 is configured to interact with other components like a database on the server. In at least some embodiments, server model 224 is represented as a data structure. In at least some embodiments, layers that are included in server model 224 are identical in dimensionality, type, and order to full model 220. In at least some embodiments, any layers of full model 220 that are not included in server model 224 are included in device model 221.

Auxiliary model 225 includes an initial layer and a final layer having the same dimensionality as the initial layer and the final layer of server model 224. In at least some embodiments, input and output dimensionality of auxiliary model 225 is identical to input and output dimensionality of server model 224. In at least some embodiments, auxiliary model 225 is an additional model. In at least some embodiments, auxiliary model 225 is used for local training of device model 221. In at least some embodiments, auxiliary model 225 is generated based on server model 224. In at least some embodiments, auxiliary model 225 includes fewer layers than server model 224. In at least some embodiments, auxiliary model 225 includes one or two layers. In at least some embodiments, auxiliary model 225 is represented as a data structure. In at least some embodiments, auxiliary model 225 is of a type used in any machine learning task that requires auxiliary models, not just federated learning. In at least some embodiments, each updated device model includes a corresponding updated auxiliary model, and each aggregated device model includes a corresponding aggregated auxiliary model.

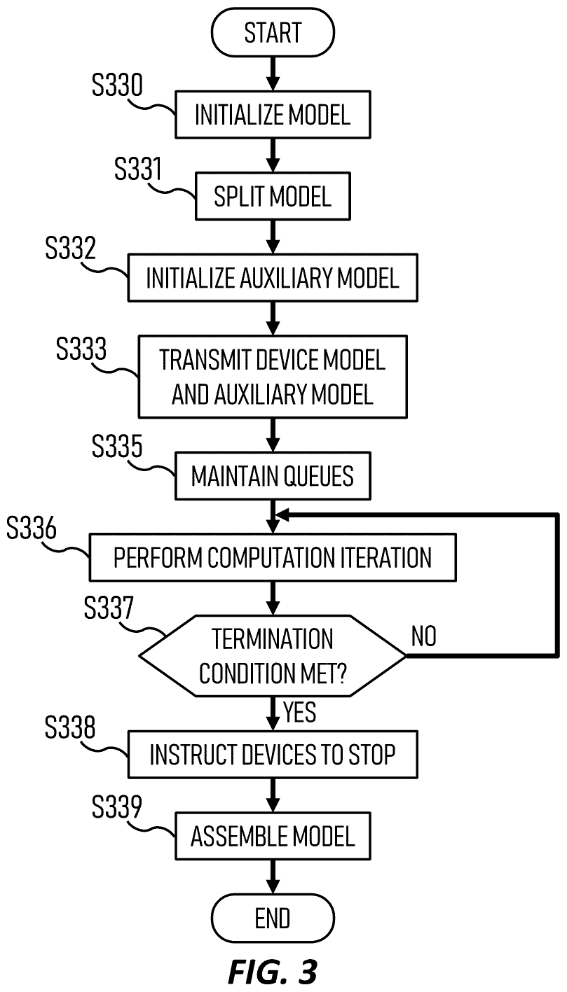

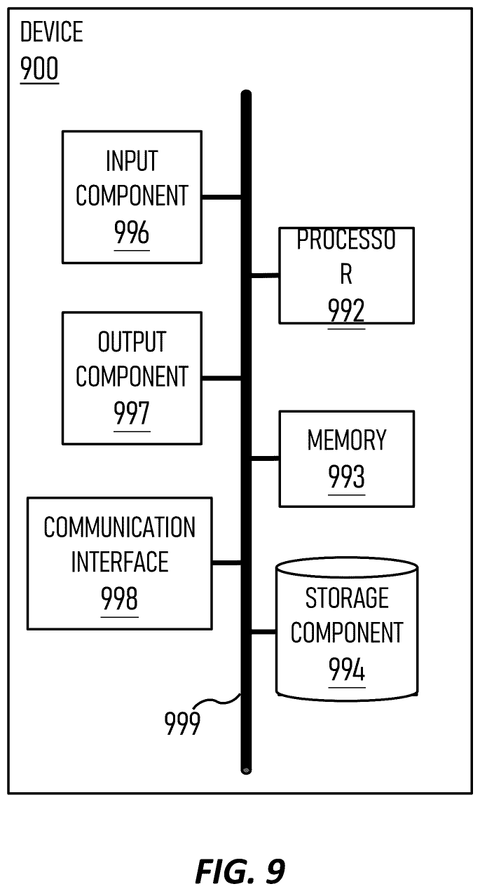

FIG. 3 is an operational flow for federated learning with increased resource utilization on a server, according to at least some embodiments of the subject disclosure. In at least some embodiments, the operational flow provides a method of federated learning with increased resource utilization on a server, according to at least some embodiments of the subject disclosure. In at least some embodiments, the method is performed by a processor of a device, such as processor 992 of device 990 of FIG. 9, described hereinafter.

At S330, the processor initializes a neural network model. In at least some embodiments, the processor sets initial values for the parameters of the neural network model. In at least some embodiments, the processor sets initial values for the parameters of a full model. In at least some embodiments, the processor sets initial values between zero and one at random.

At S331, the processor splits the neural network model. In at least some embodiments, the processor splits the initialized neural network model into a device model and a server model. In at least some embodiments, the processor partitions the layers of the neural network model. In at least some embodiments, the processor selects a location to split the model to balance processing time between the server and the devices. In at least some embodiments, the processor splits the model such that the device model has fewer layers than the server model.

At S332, the processor initializes an auxiliary model. In at least some embodiments, the processor initializes an auxiliary model based on the server model. In at least some embodiments, the processor sets initial values for the parameters of the auxiliary model. In at least some embodiments, the processor sets initial values between zero and one at random.

At S333, the processor transmits the device model and auxiliary model to each device. In at least some embodiments, the processor transmits the device model and the auxiliary model to each device among the plurality of devices. In at least some embodiments, the processor instructs a server transmitter to send the models to each device. In at least some embodiments, the processor transmits the models together after the auxiliary model initialization. In at least some embodiments, the processor transmits the models separately.

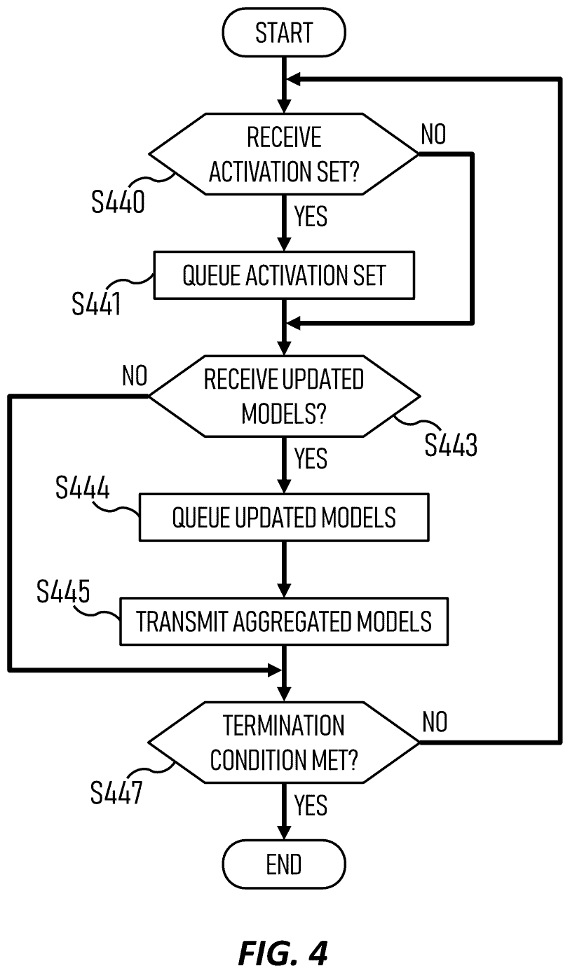

At S335, the processor maintains an activation queue and a model queue. In at least some embodiments, the processor instructs a task scheduler to maintain the activation queue and the model queue. In at least some embodiments, the processor adds activation sets and updated models to the respective queues upon reception from the devices. In at least some embodiments, the processor maintains the activation queue and the model queue on a rolling basis while performing computation iterations, such as computation iteration performance at S336. In at least some embodiments, the processor maintains an activation queue by adding, upon reception from a corresponding device among a plurality of devices, each activation set among a plurality of activation sets in the activation queue, each activation set having been output from a device model of a neural network model, the neural network model including a plurality of layers partitioned into the device model and a server model. In at least some embodiments, the processor maintains a model queue by adding, upon reception from a corresponding device among the plurality of devices, each updated device model and corresponding updated auxiliary model among a plurality of updated models in the model queue. In at least some embodiments, the processor performs this action continuously throughout the federated learning process. In at least some embodiments, the processor performs the operational flow of FIG. 4, described hereinafter.

At S336, the processor performs computation iterations. In at least some embodiments, the processor determines whether to perform aggregation or training, and then performs the chosen operation. In at least some embodiments, the processor performs computation iterations as long as the termination condition is not met. In at least some embodiments, the processor performs computation iterations while maintaining the activation queue and the model queue.

At S337, the processor determines whether the termination condition is met. In response to the termination condition not being met, the operational flow returns to computation iteration performance at S336. In response to the termination condition being met, the operational flow proceeds to device stop instruction at S338. In at least some embodiments, the processor evaluates a condition, such as whether a global loss has converged, or whether a number of computation iterations has been reached. In at least some embodiments, the processor discontinues the computation iterations in response to the global loss converging. In at least some embodiments, the processor performs this determination after each computation iteration.

At S338, the processor instructs the devices to stop. In at least some embodiments, the processor instructs the devices to stop training the device model and transmitting models and activation sets. In at least some embodiments, the processor transmits a signal or message to each device.

At S339, the processor assembles a model. In at least some embodiments, the processor assembles the trained neural network model. In at least some embodiments, the processor combines a trained server model with an aggregated device model.

FIG. 4 is an operational flow for maintaining queues, according to at least some embodiments of the subject disclosure. In at least some embodiments, the operational flow provides a method of maintaining queues, according to at least some embodiments of the subject disclosure. In at least some embodiments, the method is performed by a processor of a device, such as processor 992 of device 990 of FIG. 9, described hereinafter.

At S440, the processor determines whether an activation set has been received. In response to not receiving an activation set, the operational flow proceeds to model reception at S443. In response to receiving an activation set, the operational flow proceeds to activation set queueing at S441. In at least some embodiments, the processor receives an activation set from a device among a plurality of devices.

At S441, the processor queues the activation set. In at least some embodiments, the processor adds the received activation set to the activation queue. In at least some embodiments, the processor adds the received activation set to the activation queue corresponding to the device from which the activation set was received. In at least some embodiments, the processor orders the received activation set in the activation queue to balance training with respect to the devices. In at least some embodiments, the processor maintains the activation queue includes adding each activation set to an individual activation queue corresponding to the corresponding device. In at least some embodiments, the processor maintains the activation queue, including ordering the plurality of activation sets to prioritize activation sets of corresponding devices, the activation sets of which are least used in the training.

At S443, the processor determines whether updated models have been received. In response to not receiving updated models, the operational flow proceeds to termination condition determination at S447. In response to receiving updated models, the operational flow proceeds to queue the updated models at S444. In at least some embodiments, the processor receives an updated device model and a corresponding updated auxiliary model from a single device. In at least some embodiments, in response to receiving updated models, the processor instructs a task scheduler to queue the updated models.

At S444, the processor queues the updated models. In at least some embodiments, the processor adds the received updated models to the model queue. In at least some embodiments, the processor adds the received updated models to the end of the model queue.

At S445, the processor transmits aggregated models. In at least some embodiments, the processor transmits an aggregated device model and an aggregated auxiliary model to the corresponding device. In at least some embodiments, the processor transmits an aggregated device model and an aggregated auxiliary model to the device from which the updated models were received. In at least some embodiments, the processor transmits an aggregated device model and an aggregated auxiliary model to the corresponding device in response to reception of each updated device model and corresponding updated auxiliary model. In at least some embodiments, the processor only transmits an aggregated device model and an aggregated auxiliary model to the device from which the updated models were received after performing aggregation among the computation iterations, such as at S336 of FIG. 3.

At S447, the processor determines whether a termination condition has been met. In response to the termination condition not being met, the operational flow returns to activation set reception determination at S440. In response to the termination condition being met, the operational flow ends. In at least some embodiments, the processor evaluates a condition, such as whether a global loss has converged, or whether a number of computation iterations has been reached. In at least some embodiments, operation S447 is identical to operation S337 of FIG. 3.

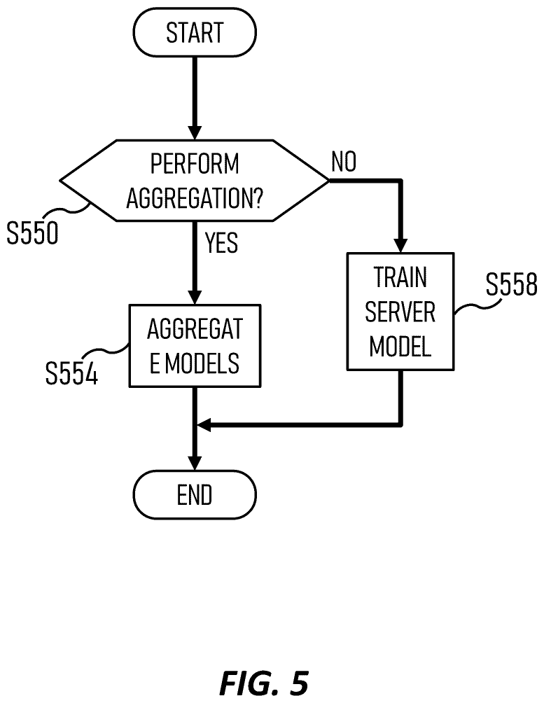

FIG. 5 is an operational flow for performing computations, according to at least some embodiments of the subject disclosure. In at least some embodiments, the operational flow provides a method of performing computations, according to at least some embodiments of the subject disclosure. In at least some embodiments, the method is performed by a processor of a device, such as processor 992 of device 990 of FIG. 9, described hereinafter.

At S550, the processor determines whether to perform aggregation. In response to the processor determining to perform aggregation, the operational flow proceeds to model aggregation at S554. In response to the processor determining not to perform aggregation, the operational flow proceeds to server model training at S558. In at least some embodiments, the processor determination is based on the current state of the model queue. In at least some embodiments, the processor determines whether to perform aggregation based on the availability of updated models in the model queue. In at least some embodiments, the processor determines whether there are any updated models in the model queue that have not been used for adjusting the aggregated models. In at least some embodiments, the processor determines to not perform aggregation only in response to the model queue not containing any unaggregated models. In at least some embodiments, the processor determines whether to perform aggregation includes determining whether the model queue has any updated models that have yet to be the basis for the adjusting.

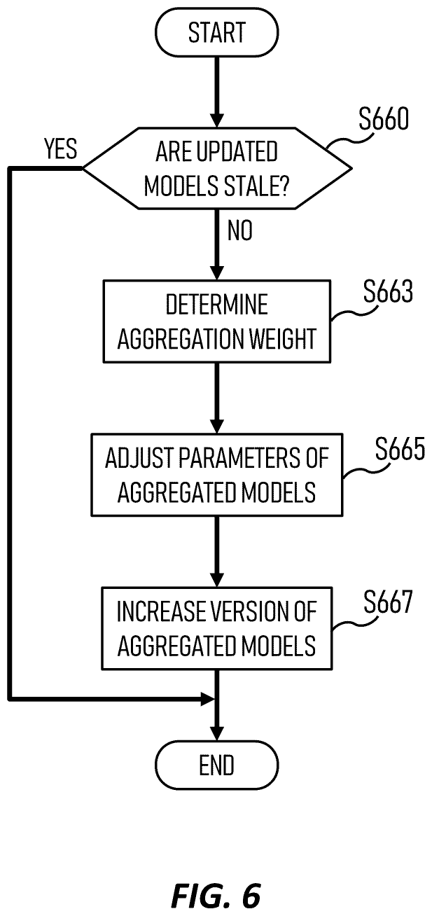

At S554, the processor aggregates models. In at least some embodiments, the processor performs aggregation with respect to one updated device model and one corresponding updated auxiliary model. In at least some embodiments, the processor performs the operation of flow of FIG. 6, described hereinafter.

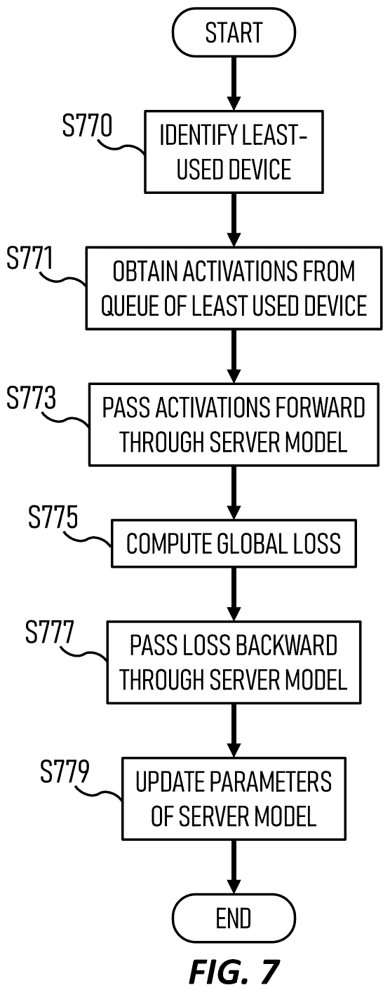

At S558, the processor trains the server model. In response to the completion of the training, the operational flow returns to the decision-making process at S550. In at least some embodiments, the processor trains the server model based on one activation set in the activation queue. In at least some embodiments, the processor trains in response to not determining to perform aggregation, the server model based on a first activation set among the plurality of activation sets in the activation queue. In at least some embodiments, the processor performs the operational flow of FIG. 7, described hereinafter.

FIG. 6 is an operational flow for aggregating device model, according to at least some embodiments of the subject disclosure. In at least some embodiments, the operational flow provides a method of aggregating device model, according to at least some embodiments of the subject disclosure. In at least some embodiments, the method is performed by a processor of a device, such as processor 992 of device 990 of FIG. 9, described hereinafter.

At S660, the processor determines whether updated models are stale. In response to the updated models not being stale, the operational flow proceeds to aggregation weight determination at S663. In response to the updated models being stale, the operational flow ends. In at least some embodiments, the processor compares a version of the updated models with a version of the aggregated models. In at least some embodiments, the processor determines that the updated models are stale in response to determining that the version of the updated models is less than the version of the aggregated models by an amount greater than a threshold value. In at least some embodiments, the processor performs this determination to avoid a risk of decreasing accuracy.

At S663, the processor determines an aggregation weight. In at least some embodiments, the processor calculates the aggregation weight. In at least some embodiments, the processor calculates the aggregation weight based on the difference between the version of the updated models and the version of the aggregated models. In at least some embodiments, the aggregation weight represents the proportion by which the aggregated device model and the aggregated auxiliary model will be adjusted. In at least some embodiments, the processor calculates the aggregation weight such that older updated models have less impact on the aggregated models than more recent updated models. In at least some embodiments, the processor determines an aggregation weight based on the difference between a version number of the updated device model and a version number of the aggregated device model, the aggregation weight representing a proportion by which the aggregated device model and the aggregated auxiliary model will be adjusted. In at least some embodiments, the processor determines the aggregation weight a according to the following formula:

$$α ← \frac{1}{t - {t}_{k} + 1} \qquad EQ . 1$$

where t represents the version of the aggregated models, and tₖ represents the version of the updated models.

At S665, the processor adjusts parameters of aggregated models. In at least some embodiments, the processor adjusts the parameters of the aggregated device model and the aggregated auxiliary model. In at least some embodiments, the processor adjusts, in response to determining to perform aggregation, parameters of the aggregated device model and the aggregated auxiliary model based on a first updated device model and corresponding first updated auxiliary model among the plurality of updated models in the model queue. In at least some embodiments, the processor adjusts the parameters based on the first updated device model and the corresponding first updated auxiliary model in the model queue. In at least some embodiments, the processor adjusts the parameters using the previously determined aggregation weight. In at least some embodiments, the processor adjusts the aggregated device model parameters Oa and the aggregated auxiliary model parameters \tilde{θ}_{d} a according to the following formulae:

$${θ}_{d} ← α {θ}_{{d}_{k}} + ( 1 - α ) {θ}_{d} \qquad EQ . 2$$

$${\tilde{θ}}_{d} ← α {\tilde{θ}}_{{d}_{k}} + ( α ) {\tilde{θ}}_{d} . \qquad EQ . 3$$

At S667, the processor increases the version of aggregated models. In at least some embodiments, the processor increases the version number of the aggregated device model and the aggregated auxiliary model. In at least some embodiments, the processor increases the version number of the aggregated device model and the aggregated auxiliary model by one to track the iterations of the aggregation process and to determine the aggregation weight in subsequent iterations. In at least some embodiments, the processor increases the version number of the aggregated device model and the aggregated auxiliary model.

FIG. 7 is an operational flow for training a server model, according to at least some embodiments of the subject disclosure. In at least some embodiments, the operational flow provides a method of training a server model, according to at least some embodiments of the subject disclosure. In at least some embodiments, the method is performed by a processor of a device, such as processor 992 of device 990 of FIG. 9, described hereinafter.

At S770, the processor or a section thereof identifies the least-used device. In at least some embodiments, the processor identifies the device whose activation sets have been used the least in training the server model. In at least some embodiments, the training includes identifying the first activation set based on the corresponding device from which activation sets have been used the least in training. In at least some embodiments, the processor refers to an activation queue from each device. In at least some embodiments, the processor refers to a usage count associated with the activation queue from each device. In at least some embodiments, the processor balances contributions of devices to the training of the server model, reducing bias towards a particular device.

At S771, the processor or a section thereof retrieves the activation set from the queue of the least-used device. In at least some embodiments, the processor retrieves the activation set from the queue of the least-used device identified in the previous operation.

At S773, the processor or a section thereof performs forward passes through the server model. In at least some embodiments, the processor inputs the obtained activations into the server model. In at least some embodiments, the processor performs forward passes to compute an output set, each output in the output set corresponding to an activation in the activation set.

At S775, the processor or a section thereof computes the global loss. In at least some embodiments, the processor computes the global loss according to a predefined loss function. In at least some embodiments, the processor uses the outputs from the previous operation to compute the global loss. In at least some embodiments, the processor quantifies the discrepancy between the server model's predictions and the ground truth.

At S777, the processor or a section thereof performs a backward pass through the server model. In at least some embodiments, the processor uses the computed global loss to compute the gradients of the model parameters. In at least some embodiments, in response to performing a backward pass, the processor generates the gradients needed to update the parameters of the server model.

At S779, the processor or a section thereof updates the parameters of the server model. In at least some embodiments, the processor uses the computed gradients to update the parameters. In at least some embodiments, the processor adjusts the parameters to minimize the global loss and improve the model's performance.

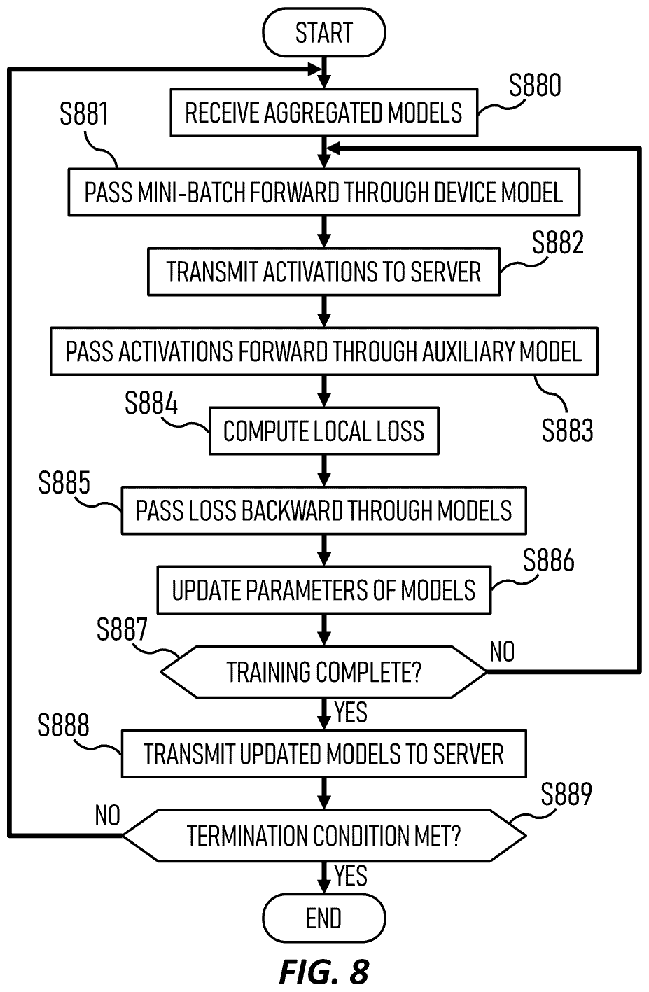

FIG. 8 is an operational flow for federated learning with increased resource utilization on a device, according to at least some embodiments of the subject disclosure. In at least some embodiments, the operational flow provides a method of federated learning with increased resource utilization on a device, according to at least some embodiments of the subject disclosure. In at least some embodiments, the method is performed by a processor of a device, such as processor 992 of device 990 of FIG. 9, described hereinafter.

At S880, the processor receives aggregated models. In at least some embodiments, the processor receives the aggregated device model and the aggregated auxiliary model from the server. In at least some embodiments, the processor replaces any locally stored models with the aggregated device model and the aggregated auxiliary model from the server. In at least some embodiments, the processor performs operations using the aggregated device model and the aggregated auxiliary model most recently received from the server.

At S881, the processor passes a mini-batch forward through the device model. In at least some embodiments, the processor passes a mini-batch of local input data through the device model. In at least some embodiments, the processor performs the backward-pass in response to receipt of the mini-batch of data and the aggregated device model. In at least some embodiments, the device model generates activations at the final layer of the device model.

At S882, the processor transmits activations to the server. In at least some embodiments, the processor transmits the activations generated by the device model to the server. In at least some embodiments, the processor accumulates activations for the entire mini-batch before transmission. In at least some embodiments, the processor transmits the activations to the server at once.

At S883, the processor passes activations forward through the auxiliary model. In at least some embodiments, the processor causes the auxiliary model to generate output.

At S884, the processor computes the local loss. In at least some embodiments, the processor computes the local loss based on the outputs of the auxiliary model and the ground truth. In at least some embodiments, the processor computes the local loss according to a predefined loss function. In at least some embodiments, the predefined loss function is the same that the server uses for computation of global loss.

At S885, the processor passes the local loss backward through the models. In at least some embodiments, the processor performs backpropagation based on the local loss, computing the gradients of the device model and the auxiliary model. In at least some embodiments, the processor treats the device model and the auxiliary model as a single model.

At S886, the processor updates parameters of the models. In at least some embodiments, the processor updates the parameters of the device model and the auxiliary model based on the gradients.

At S887, the processor determines whether the training is complete. In response to the processor determining that the training is not complete, the operational flow returns to forward passing at S881. In response to the processor determining that the training is not complete, the operational flow proceeds to updated model transmission at S888. In at least some embodiments, the processor determines whether to proceed to transmission or return to passing based on whether a number of training iterations have exceeded a threshold value.

At S888, the processor transmits updated models to the server. In at least some embodiments, the processor sends the updated device model and the updated auxiliary model to the server in response to completion of training. In at least some embodiments, the processor causes a server transmitter to transmit the updated models to the cues.

At S889, the processor determines whether the termination condition is met. In response to the processor determining that the termination condition is met, the operational flow ends. In response to the processor determining that the termination condition is not met, the operational flow returns to aggregated model receiving at S880.

FIG. 9 illustrates an embodiment of a device 990 for federated learning with increased resource utilization, according to at least some embodiments of the subject disclosure. As shown in FIG. 9, device 990 includes processor 992, memory 993, storage component 994, input component 996, output component 997, communication interface 998, and bus 999.

The processor 992, as used herein, means any type of computational circuit that may comprise hardware elements and software elements. The processor 992 may be embodied as a multi-core processor, a single core processor, or a combination of one or more multi-core processors and/or one or more single core processors, a distributed processing system, or the like. The processor 992 may be a Central Processing Unit (CPU), a graphics processing unit (GPU), an accelerated processing unit (APU), an application-specific integrated circuit (ASIC), or another type of processing component.

Memory 993 includes a non-transitory computer readable medium. memory 993 includes a random-access memory (RAM), a read only memory (ROM), and/or another type of dynamic or static storage device (e.g., a flash memory, a magnetic memory, and/or an optical memory) that stores information and/or instructions for use by processor 992. The memory 993 comprises machine-readable instructions which are executable by the processor 992. These machine-readable instructions when executed by the processor 992 cause the processor 992 to perform one or more method steps of an embodiment described above.

Storage component 994 stores information and/or software related to the operation and use of the device 990. For example, storage component 994 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 996 is configured to receive information, such as user input. For example, the input component 996 may include, but not be limited to, a touch screen display, a keyboard, a keypad, a mouse, a button, a switch, and/or a microphone. Additionally, or alternatively, the input component 996 may include a sensor for sensing information (e.g., a global positioning system (GPS), an accelerometer, a gyroscope, and/or an actuator).

Output component 997 is configured to provide output information from the device 990. For example, the output component 997 may be, but not limited to, a display, a speaker, an instruction device to an external device, and/or one or more light-emitting diodes (LEDs).

Communication interface 998 is an interface that provides a communication connection to other devices, such as external devices and internal devices. The connection by the communication interface 998 can be a wired connection, a wireless connection, or a combination of wired and wireless connections, and can be a direct connection or an indirect connection via a communication network that exists between the device 990 and other devices. In other words, the standard of the communication interface 998 is not limited.

The bus 999 acts as an interconnect between the processor 992, the memory 993, the storage component 994, the input component 996, the output component 997, and the communication interface 998 of the device 990. The bus 999 may include a wired interconnection or a wireless interconnection.

The number and arrangement of components shown in FIG. 9 are provided as an example. In practice, device 990 may include additional components, fewer components, different components, or differently arranged components than those shown in FIG. 9. Additionally, or alternatively, a set of components (e.g., one or more components) of device 990 may perform one or more functions described as being performed by another set of components of device 990. Further, one or more method steps described in any of the embodiments may be performed utilizing a plurality of device 990 in communication with one another.

In at least some embodiments, federated learning with increased resource utilization is performed by maintaining an activation queue by adding, upon reception from a corresponding device among a plurality of devices, each activation set among a plurality of activation sets in the activation queue, each activation set having been output from a device model of a neural network model, the neural network model including a plurality of layers partitioned into the device model and a server model, maintaining a model queue by adding, upon reception from a corresponding device among the plurality of devices, each updated device model and corresponding updated auxiliary model among a plurality of updated models in the model queue, transmitting an aggregated device model and an aggregated auxiliary model to the corresponding device in response to reception of each updated device model and corresponding updated auxiliary model, performing computation iterations while maintaining the activation queue and the model queue, each computation iteration including: determining whether to perform aggregation, adjusting, in response to determining to perform aggregation, parameters of the aggregated device model and the aggregated auxiliary model based on a first updated device model and corresponding first updated auxiliary model among the plurality of updated models in the model queue, and training, in response to not determining to perform aggregation, the server model based on a first activation set among the plurality of activation sets in the activation queue. In at least some embodiments, each updated device model includes a corresponding updated auxiliary model, and wherein each aggregated device model includes a corresponding aggregated auxiliary model. In at least some embodiments, the determining whether to perform aggregation includes determining whether the model queue has any updated models that have yet to be the basis for the adjusting. In at least some embodiments, the training includes identifying the first activation set based on the corresponding device from which activation sets have been used the least in training. In at least some embodiments, the maintaining the activation queue includes adding each activation set to an individual activation queue corresponding to the corresponding device. In at least some embodiments, the maintaining the activation queue includes ordering the plurality of activation sets to prioritize activation sets of corresponding devices, the activation sets of which are least used in the training. In at least some embodiments, the adjusting includes determining an aggregation weight based on the difference between a version number of the updated device model and a version number of the aggregated device model, the aggregation weight representing a proportion by which the aggregated device model and the aggregated auxiliary model will be adjusted. In at least some embodiments, the adjusting includes increasing the version number of the aggregated device model and the aggregated auxiliary model. In at least some embodiments, federated learning with increased resource utilization further includes initializing the neural network model, splitting the neural network model into the device model and the server model, initializing the auxiliary model based on the server model, and transmitting the device model and the auxiliary model to each device among the plurality of devices. In at least some embodiments, input and output dimensionality of the auxiliary model is identical to input and output dimensionality of the server model. In at least some embodiments, the training includes computing a global loss according to a loss function. In at least some embodiments, federated learning with increased resource utilization further includes discontinuing the computation iterations in response to the global loss converging.

In at least some embodiments, federated learning with increased resource utilization is performed by a processor executing instructions in accordance with the foregoing operations or a device comprising a controller including circuitry configured to perform the foregoing operations.

What is claimed is:

1. A non-transitory computer-readable medium having instructions recorded thereon that, in response to execution by one or more processors, cause performance of operations comprising:
maintaining an activation queue by adding, upon reception from a corresponding device among a plurality of devices, each activation set among a plurality of activation sets in the activation queue, each activation set having been output from a device model of a neural network model, the neural network model including a plurality of layers partitioned into the device model and a server model;
maintaining a model queue by adding, upon reception from a corresponding device among the plurality of devices, each updated device model and corresponding updated auxiliary model among a plurality of updated models in the model queue;
transmitting an aggregated device model and an aggregated auxiliary model to the corresponding device in response to reception of each updated device model and corresponding updated auxiliary model;
performing computation iterations while maintaining the activation queue and the model queue, each computation iteration including:
determining whether to perform aggregation;
adjusting, in response to determining to perform aggregation, parameters of the aggregated device model and the aggregated auxiliary model based on a first updated device model and corresponding first updated auxiliary model among the plurality of updated models in the model queue; and
training, in response to not determining to perform aggregation, the server model based on a first activation set among the plurality of activation sets in the activation queue.

2. The computer-readable medium of claim 1, wherein the determining whether to perform aggregation includes determining whether the model queue has any updated models that have yet to be the basis for the adjusting.

3. The computer-readable medium of claim 1, wherein the training includes identifying the first activation set based on the corresponding device from which activation sets have been used the least in training.

4. The computer-readable medium of claim 1, wherein the maintaining the activation queue includes adding each activation set to an individual activation queue corresponding to the corresponding device.

5. The computer-readable medium of claim 1, wherein the maintaining the activation queue includes ordering the plurality of activation sets to prioritize activation sets of corresponding devices, the activation sets of which are least used in the training.

6. The computer-readable medium of claim 1, wherein the adjusting includes determining an aggregation weight based on the difference between a version number of the updated device model and a version number of the aggregated device model, the aggregation weight representing a proportion by which the aggregated device model and the aggregated auxiliary model will be adjusted.

7. The computer-readable medium of claim 6, wherein the adjusting includes increasing the version number of the aggregated device model and the aggregated auxiliary model.

8. The computer-readable medium of claim 1, wherein the operations further comprise initializing the neural network model;
splitting the neural network model into the device model and the server model;
initializing an auxiliary model based on the server model; and
transmitting the device model and the auxiliary model to each device among the plurality of devices.

9. The computer-readable medium of claim 8, wherein input and output dimensionality of the auxiliary model is identical to input and output dimensionality of the server model.

10. The computer-readable medium of claim 1, wherein the training includes computing a global loss according to a loss function.

11. The computer-readable medium of claim 1, wherein the operations further comprise discontinuing the computation iterations in response to the global loss converging.

12. A method comprising:
maintaining an activation queue by adding, upon reception from a corresponding device among a plurality of devices, each activation set among a plurality of activation sets in the activation queue, each activation set having been output from a device model of a neural network model, the neural network model including a plurality of layers partitioned into the device model and a server model;
maintaining a model queue by adding, upon reception from a corresponding device among the plurality of devices, each updated device model and corresponding updated auxiliary model among a plurality of updated models in the model queue;
transmitting an aggregated device model and an aggregated auxiliary model to the corresponding device in response to reception of each updated device model and corresponding updated auxiliary model; and
performing computation iterations while maintaining the activation queue and the model queue, each computation iteration including:
determining whether to perform aggregation;
adjusting, in response to determining to perform aggregation, parameters of the aggregated device model and the aggregated auxiliary model based on a first updated device model and corresponding first updated auxiliary model among the plurality of updated models in the model queue; and
training, in response to not determining to perform aggregation, the server model based on a first activation set among the plurality of activation sets in the activation queue.

13. The method of claim 12, wherein the determining whether to perform aggregation includes determining whether the model queue has any updated models that have yet to be the basis for the adjusting.

14. The method of claim 12, wherein the training includes identifying the first activation set based on the corresponding device from which activation sets have been used the least in training.

15. The method of claim 12, wherein the maintaining the activation queue includes adding each activation set to an individual activation queue corresponding to the corresponding device.

16. The method of claim 12, wherein the maintaining the activation queue includes ordering the plurality of activation sets to prioritize activation sets of corresponding devices, the activation sets of which are least used in the training.

17. The method of claim 12, wherein the adjusting includes determining an aggregation weight based on the difference between a version number of the updated device model and a version number of the aggregated device model, the aggregation weight representing a proportion by which the aggregated device model and the aggregated auxiliary model will be adjusted.

18. The method of claim 17, wherein the adjusting includes increasing the version number of the aggregated device model and the aggregated auxiliary model.

19. The method of claim 12, further comprising
initializing the neural network model;
splitting the neural network model into the device model and the server model;
initializing an auxiliary model based on the server model; and
transmitting the device model and the auxiliary model to each device among the plurality of devices.

20. A device comprising:
a controller including circuitry configured to perform operations including
maintaining an activation queue by adding, upon reception from a corresponding device among a plurality of devices, each activation set among a plurality of activation sets in the activation queue, each activation set having been output from a device model of a neural network model, the neural network model including a plurality of layers partitioned into the device model and a server model;
maintaining a model queue by adding, upon reception from a corresponding device among the plurality of devices, each updated device model and corresponding updated auxiliary model among a plurality of updated models in the model queue;
transmitting an aggregated device model and an aggregated auxiliary model to the corresponding device in response to reception of each updated device model and corresponding updated auxiliary model; and
performing computation iterations while maintaining the activation queue and the model queue, each computation iteration including:
determining whether to perform aggregation;
adjusting, in response to determining to perform aggregation, parameters of the aggregated device model and the aggregated auxiliary model based on a first updated device model and corresponding first updated auxiliary model among the plurality of updated models in the model queue; and
training, in response to not determining to perform aggregation, the server model based on a first activation set among the plurality of activation sets in the activation queue.
